(19) United States
(12) Patent Application Publication
(10) Pub. No.: US 2024/0172259 A1
(43) Pub. Date: May 23, 2024

(54) METHOD AND APPARATUS FOR MANAGING LOW LATENCY DATA TRANSMISSION IN A WIRELESS NETWORK

(71) Applicant: CANON KABUSHIKI KAISHA, Tokyo (JP)

(72) Inventors: Julien SEVIN, SAINT AUBIN DU CORMIER (FR); Patrice NEZOU, LIFFRE (FR); Romain GUIGNARD, RENNES (FR)

(21) Appl. No.: 18/552,151

(22) PCT Filed: Mar. 18, 2022
(86) PCT No.: PCT/EP2022/057191

§ 371 Date: Sep. 22, 2023

(30) Foreign Application Priority Data
Mar. 26, 2021 (GB) 2104295.7

(51) Int. Cl. H04W 72/512; H04W 28/02; H04W 72/12

(52) U.S. Cl. CPC H04W 72/512; H04W 28/0268; H04W 72/12

(57) ABSTRACT

802.11be wireless networks implement Low Latency Reliable Service measures to prioritize LLRS traffic over conventional not-LLRS traffic. The AP dynamically defines and modifies LLRS traffic configurations made of concerned traffics and associated QoS, through transmission of management frames to the non-AP stations. The AP guarantees the declared QoS applicable to each type of declared traffic profile by scheduling appropriate resources to the LLRS traffic configurations. A monitoring of a correct use of the scheduled resources by the non-AP stations helps avoiding abuses. Plural LLRS traffic configurations can be defined simultaneously within the same frame, using sequential listing or inheritance scheme.

### FIELD OF THE INVENTION

The present disclosure concerns a method and a device for managing low latency transmission in a wireless network. It concerns more particularly a method able to guarantee transmission constraints such as Quality-of-service constraints, for example in term of latency in the transmission.

### BACKGROUND OF INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The 802.11 family of standards adopted by the Institute of Electrical and Electronics Engineers (IEEE-®) provides a great number of mechanisms for wireless communications between stations.

With the development of latency sensitive applications such as online gaming, real-time video streaming, virtual reality, drone or robot remote controlling, better QoS requirements, such as low latency and robustness requirements and issues need to be taken into consideration. For instance, 99.9% of latency sensitive packets should be delivered to the end equipment within a 2 ms latency.

Such issues are currently under consideration by the IEEE 802.11 working group as a main objective to issue the next major 802.11 release, known as 802.11be or EHT for “Extremely High Throughput”.

Low latency reliable services, LLRS, have been defined as targets of such main objective. LLRSs are services provided to a higher layer traffic stream that prioritize and deliver MSDUs (data units) within a worst-case latency budget with a given reliability/packet delivery ratio (PDR) and low jitter. This traffic stream prioritized by the LLRS is named LLRS traffic.

Some low latency, LL, measures are being studied in order to prioritize LLRS traffic within a BSS (Basic Service Set) managed by an access point (AP) station, with a view of meeting quality of service, QoS, constraints.

Some LL measures have been proposed where the AP station schedules a protected/restricted TWT service period for a given LLRS traffic. As proposed in the IEEE 802.11-20/1046r2 document, non-AP stations that do not participate to the LLRS traffic (i.e. passive stations) shall stop their current transmission opportunity, TXOP, before the protected TWT service period starts, with a view of reducing their impact on the network.

Another non-limiting example of LL measures is applied by non-AP stations emitting or receiving the LLRS traffic (active stations). For instance, specific LLRS resources, such as frequency, temporal or spatial resources, are assigned by the AP station to LLRS traffic and thus used. An example is provided in the IEEE 802.11-20/0418r4 document where TID>7 is used to signal network resources for LLRS traffic.

An efficient QoS management in the BSS is required to provide LL reliable services.

### SUMMARY OF THE INVENTION

The present invention has been devised to address one or more of the foregoing concerns.

It first concerns a communication method in a wireless network, comprising at an access point, AP, station of a basic service set, BSS:
declaring, to one or more non-AP stations, one or more QoS parameters applicable to traffic matching a defined traffic profile, and
scheduling, in the BSS, resources of the wireless network to traffic matching the defined traffic profile based on the applicable declared QoS parameters.

The set made of a traffic profile and associated applicable QoS parameters forms one configuration of LLRS traffic, below referred to as LLRS traffic configuration.

Contrary to statically defined 802.11e Access Categories, the AP station according to the invention can dynamically declare and update LLRS traffic configurations, i.e. which traffic it intends to process as LLRS traffic using LL measures. The proposed scheduling thus guarantees the resources offered to the BSS meet the declared QoS constraints.

Indeed, the AP station may first receive non-AP stations' needs in term of LLRS traffic matching one or more traffic profiles (for instance through dedicated Buffer Status Report, BSR, procedure). It may then determine the wireless resources in terms of bandwidth and duration (e.g. Multi-User UpLink resource units) to offer to the non-AP stations given their respective needs to guarantee the QoS applicable to the traffic profile considered.

The invention also concerns a communication method in a wireless network, comprising at a non-access point, non-AP, station:
receiving, from an AP station of a basic service set, BSS, a frame declaring one or more QOS parameters applicable to traffic matching a defined traffic profile, and
accessing resources of the wireless network that are scheduled by the AP in the BSS to traffic matching the defined traffic profile in order to receive or send such traffic.

The non-AP stations thus become aware of the LLRS traffic configuration, i.e; of which traffics are to be processed as LLRS traffic by the AP station (by comparison to the conventional 802.11e Access Categories) with own QoS constraints. They can then use appropriate scheduled resources served by the AP station.

Correlatively, the invention also provides a wireless communication device comprising at least one microprocessor configured for carrying out the steps of any of the above methods.

Optional features of embodiments of the invention are defined in the appended claims. Some of these features are explained here below with reference to a method, while they can be transposed into device features.

In some embodiments, declaring includes using a management frame, such as a beacon frame or a probe response frame, sent by the AP station during the association of the non-AP station with the AP station. This helps the non-AP station to decide to actually join or not the BSS, should the declared LLRS traffic configurations match or not its needs.

In other embodiments, declaring includes using a management frame, such as a beacon frame or an action frame, sent by the AP station to the non-AP stations of the BSS. In this way, the AP station can dynamically advertise and modify the LLRS traffic configurations (traffic profile and corresponding QoS constraints) during the life of the BSS, for instance depending on the network load. The non-AP stations receiving the management frame can then adapt their behaviour or even decide to move to another BSS if appropriate.

In some embodiments, declaring includes specifying an index referring to a predefined (LLRS traffic) configuration associating the defined traffic profile with the QoS parameters. This allows reducing the signalling overhead as long as the predefined LLRS traffic configurations are known by the stations.

In other embodiments, declaring includes specifying the one or more QoS parameters in association with a profile identifier identifying the defined traffic profile. The traffic profiles may thus be predefined and known by all the stations. The AP only specifies the QoS constraints in relation to one of the predefined traffic profiles. This reduces the overhead for declaration.

In other embodiments, declaring includes specifying the one or more QoS parameters in association with one or more traffic characteristic values defining the defined traffic profile. This gives freedom to the AP station to dynamically and finely define or modify any LLRS traffic configuration, not only in relation with the QoS constraints but also in relation with the type of data or traffic concerned.

In some embodiments, the one or more traffic characteristic values include minimum and maximum values of the same traffic characteristic. This efficiently defines LLRS traffic. Indeed, a first bound value (e.g. minimum bit rate) usually sets when the AP station believes a specific management is needed to achieve the applicable QoS. A second bound value (e.g. maximum bit rate) sets when the AP station believes it can no longer guarantee the associated QoS.

In some embodiments, declaring includes declaring a plurality of QoS parameter sets applicable to plural traffics matching respective defined traffic profiles. The AP station thus declare plural LLRS traffic configurations. Joint declaration reduces network overhead.

The plural sets (LLRS traffic configurations) may be self-defined or inherit from another yet-defined set.

For instance, a next QoS parameter set for a next defined traffic profile may be defined with inheritance from a previous QoS parameter set for a previous defined traffic profile. The next LLRS traffic configuration thus inherit from the previous LLRS traffic configuration.

According to specific features, declaring the next QoS parameter set for the next defined traffic profile includes declaring replacing values that replace one or more of QoS parameter values and traffic characteristic values of the previous QoS parameter set and defined traffic profile.

According to another specific feature, the previous QoS parameter set is the first Qos parameter set in the declared plurality. This first declared LLRS traffic configuration is thus the reference configuration for inheritance. This contributes to reduce overhead of signalling the next LLRS traffic configurations.

In some embodiments regarding the AP station, scheduling is made upon detecting needs of one or more of the stations (i.e. itself or any other non-AP station) for transmitting traffic matching the defined traffic profile. This may for instance rely for the AP station on detecting local LLRS traffic in its memories, or on receiving buffer status reports indicating LLRS traffic (or needs) from the non-AP stations. As mentioned above, the AP station can then determine the wireless resources in terms of bandwidth and duration (e.g. Multi-User UpLink resource units) to offer (i.e. schedule) to the non-AP stations given their respective needs to guarantee the QoS applicable to the traffic profile considered.

Scheduled resources may be used by the AP station to send downlink LLRS traffic to the non-AP stations of the BSS and/or be used by the non-AP stations of the BSS to send uplink LLRS traffic to the AP station or DirectLink, DiL, traffic (also known as peer-to-peer, P2P, traffic) to other non-AP stations belonging or not to the BSS.

In some embodiments, scheduling includes scheduling a protected Target Wake Time, TWT, service period for traffic matching the defined traffic profile. The TWT service period is thus provided in association with a given LLRS traffic configuration.

In other embodiments, frequency, temporal or spatial resources (e.g. resource units in a Multi-User OFDMA scheme) are provided by the AP stations for traffic matching the defined traffic profile, either as random RUs or as scheduled RUs assigned to specific non-AP stations.

In some embodiments, the method further comprises, at the AP station, monitoring use of the scheduled resources that the traffic transmitted therein matches the defined traffic profile.

In some embodiments, the method further comprises, at the AP station, upon detecting a non-AP station transmitting traffic not matching the defined traffic profile in the scheduled resources, applying a correcting measure to the detected non-AP station. Various correcting measures may be contemplated, from temporary penalizing the non-AP station (e.g. by reducing resources scheduled to it) to excluding it from the BSS.

In some embodiments, the method further comprises, at the non-AP station, determining that local traffic matches the defined traffic profile and responsively accessing the scheduled resources to send the local traffic.

In other embodiments, the method further comprises, at the non-AP station, declaring, to the AP station, local traffic matching the defined traffic profile. The declaration may include the amount of such local traffic, to help the AP station to determine the resources to be scheduled to achieve the applicable QoS.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates an exemplary network environment, in which the invention may be implemented for delivering LLRS traffic,

FIG. 2 illustrates, using a flowchart, general steps at the AP for managing the QoS for LLRS traffic according to some embodiments of the invention;

FIG. 3 illustrates, using a flowchart, general steps at a non-AP station for such LLRS QoS management according to some embodiments of the invention;

FIGS. 4a and 4b illustrate variants to signal LLRS traffic configurations according to embodiments of the invention;

FIG. 5 illustrates various embodiments for advertising one or more LLRS traffic configurations in advertising frames;

FIG. 6 illustrates an exemplary table of predefined LLRS traffic configurations according to embodiments of the invention;

FIG. 7a schematically illustrates a communication device, either a non-AP station or the AP, of a radio network, configured to implement at least one embodiment of the present invention; and

FIG. 7b is a block diagram schematically illustrating an architecture of a communication device adapted to carry out, at least partially, the invention.

### DETAILED DESCRIPTION OF THE INVENTION

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to simultaneously transmit data belonging to multiple user terminals, i.e. wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (so-called AP) or not (so-called non-AP station or STA).

While the examples are described in the context of WiFi® networks, the invention may be used in any type of wireless networks like, for example, mobile phone cellular networks that implement very similar mechanisms.

An AP may comprise, be implemented as, or known as a Node B, Radio Network Controller (“RNC”), evolved Node B (eNB), 5G Next generation base station (gNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a STA may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station may be a wireless node. Such wireless node may provide, for example, connectivity for or to a network (e.g., a wide area network such as the Internet or a cellular network) via a wired or wireless communication link.

An AP manages a set of stations that together organize their accesses to the wireless medium for communication purposes. The stations (including the AP) form a service set, here below referred to as basic service set, BSS (although other terminology can be used). A same physical station acting as an access point may manage two or more BSS (and thus corresponding WLANs): each BSS is thus uniquely identified by a specific basic service set identification, BSSID and managed by a separate virtual AP implemented in the physical AP.

Low latency reliable services, LLRS, are services provided to a higher layer traffic stream that prioritize and deliver MSDUs (data units of this traffic stream) within a worst-case latency budget with a given reliability/packet delivery ratio (PDR) and low jitter. Traffic that may be concerned by LLRS includes latency sensitive data, i.e. data from applications such as gaming, media streaming, augmented reality, virtual reality, and so on.

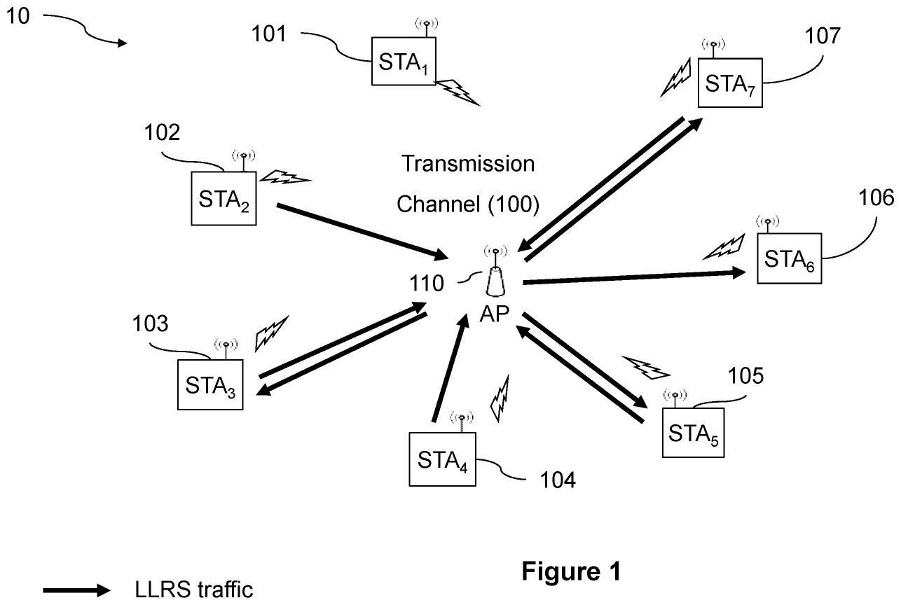

FIG. 1 illustrates an exemplary network environment 100, in which the invention may be implemented for delivering LLRS traffic.

Each communication station 101-107 registers to a central station or access point (AP) 110 during an association procedure where the AP assigns a specific Association IDentifier (AID) to the requesting non-AP station. For example, the AID, e.g. a 16-bit value uniquely identifying the non-AP station, may be used to identify the stations in the frame exchanged. The AP 110 and the associated non-AP stations 102-107 may represent a basic service set (BSS) or an extended service set (ESS).

In the example of the Figure, non-AP station 101 is not yet associated with AP 110 but it has the intention of being associated with it, either by initiating the association procedure via the transmission of a probe request frame or continuing the association procedure following the reception of a probe response frame broadcasted by AP.

Once associated with the BSS, the communication stations 101-107, 110 exchange data frames over a radio transmission channel 100 of a wireless local area network (WLAN), under control of the AP 110. The radio transmission channel 100 is defined by an operating frequency band constituted by a single channel or a plurality of channels forming a composite channel.

Non-AP stations may also communicate directly via a direct wireless link (DiL for direct link), i.e. without the intervention of the AP relaying their messages. Exemplary situation of direct communications includes the presence of peer-to-peer (P2P) transmissions between non-AP stations having the same primary channel.

The stations 101-107, 110 may compete one against the other using EDCA (Enhanced Distributed Channel Access) contention, to gain access to the wireless medium 100 in order to be granted a transmission opportunity (TXOP) and then transmit (single-user, SU) data frames. The stations may also use a multi-user (MU) scheme in which a single station, usually the AP 110, is allowed to schedule a MU transmission, i.e. multiple simultaneous transmissions to or from other stations, during a TXOP granted in the wireless network. One implementation of such a MU scheme has been for example adopted in IEEE 802.11ax amendment standard, as the Multi-User Uplink and Downlink OFDMA (MU UL and DL OFDMA) procedures. Thanks to the MU feature, a non-AP station has the opportunity to gain access to the wireless medium via two access schemes: the MU scheme and the conventional Enhanced Distributed Channel Access—EDCA (Single User) scheme.

During the MU DL transmission on the granted communication channel, the AP performs multiple simultaneous elementary transmissions, over so-called resource units (RUs), to various non-AP stations. As an example, the resource units split the communication channel of the wireless network in the frequency domain, based for instance on Orthogonal Frequency Division Multiple Access (OFDMA) technique. The assignment of the RUs to the non-AP stations is signaled at the beginning of the MU Downlink frame, by providing an association identifier (AID) of a non-AP station (individually obtained by each station during its association procedure with the AP) for each RU defined in the transmission opportunity.

During the MU UL transmission, various non-AP stations can simultaneously transmit data to the AP over the resource units forming the communication channel. To control the MU UL transmission by the non-AP stations, the AP previously sends a control frame, known as a Trigger Frame (TF) or use a TRS (standing for Trigger Response Scheduling) control subfield in previous DL data frames the AP sends. The Trigger Frame or the TRS allocates the resource units to the non-AP stations of the same BSS, using Association IDentifiers (AIDs) assigned to them upon registration to the AP and/or using reserved AIDs designating a group of non-AP stations. The TF also defines the start of the MU UL transmission by the non-AP stations as well as the length thereof.

Management of quality of service (QOS) has been introduced at station level in the wireless networks, through well-known EDCA mechanism defined in the IEEE 802.11e standard. EDCA (Enhanced Distributed Channel Access) mechanism defines four traffic access categories (ACs) or «priorities» to manage access to the medium: a voice access category (AC_VO), a video access category (AC_VI) both reserved for real-time applications (e.g. voice or video transmission), a best effort access category (AC_BE) for standard applications and a background access category (AC_BK) when traffic is low.

Four corresponding emission buffers, or transmission/traffic queues or buffers, are provided: each AC has its own traffic queue/buffer to store corresponding traffic as data frames such as MSDUs or A-MSDUs to be transmitted on the network. The data frames, namely the MSDUs, incoming from an upper layer of the protocol stack are each provided with an 802.1D priority or User priority (UP) or traffic type (TID—standing for Traffic Identifier) taking values in the range 0-7. Based on their TID, the MSDUs are mapped, using mapping rules, onto one of the four AC queues/buffers to be stored in the mapped AC buffer. Of course, another number of traffic queues may be contemplated.

Back to FIG. 1, the non-AP stations may represent various devices such as gaming client, augmented/virtual reality headset, smartphones, wireless display and some of them have to exchange (i.e. transmit or/and receives) traffic over time that has more constrained Qos requirements regarding for instance PDR, jitter and latency, than other traffic coexisting in the WLAN 100.

For instance, as explained in the IEEE 802.11-21/34r4 document, traffic originating from many real time applications has stringent latency requirements including not only very low average and worst-case values, in the order of a few to tens of milliseconds, but also small jitter. Such traffic is referred to as latency sensitive traffic or low latency, LL, traffic or LLRS traffic.

To meet the QoS requirements of such LLRS traffic as well as to optimize the network performance, the AP 110 may choose one or more links and provide differentiated quality of services over these links. Low latency operations reduces the average and worst-case latency, and jitter. This includes defining QoS management mechanisms to differentiate LLRS traffic from other traffic (i.e. non-LLRS traffic), and defining mechanisms to prioritize the transmission of the LLRS traffic.

All these LL operations are known as the Low latency Reliable Services (LLRS) of the AP which prioritize and deliver MSDUs (data units) of the LLRS traffic streams within a worst-case latency budget involving for instance a given reliability/packet delivery ratio (PDR) and a low jitter (and more generally QoS constraints).

On the other hand, non-LLRS traffic is managed using the above conventional 802.11e access category scheme.

An exemplary LLRS includes protected TWT service periods scheduled by the AP 110 for LLRS traffic. As proposed in the IEEE 802.11-20/1046r2 document, non-AP stations shall stop their current transmission opportunity, TXOP, before a protected TWT service period starts. This guarantees the resources scheduled for the LLRS traffic be used, hence the QoS constraints for LLRS traffic to be meet.

Another LLRS may consist in providing RUs or transmission links dedicated to LLRS traffic only.

Guaranteeing the QoS constraints for LLRS traffic is a tough task for the AP 110 that manages the BSS. Indeed, the network conditions can change over time: the BSS can grow or reduce, concurrent BSSs or legacy stations outside the BSS can appear and occupy the wireless medium in a more or less extent.

The capabilities of the AP to meet the QoS constraints for LLRS traffic can thus evolve. Therefore, it would be opportune for the AP to dynamically regulate the QoS constraints and/or the traffic concerned, i.e. more generally to dynamically adjust the LLRS traffic configurations.

There is thus a need for wireless networks to provide an enhanced QoS management, in particular with respect to LLRS traffic.

As shown in the embodiments below, the AP 110 declares, to one or more non-AP stations, a LLRS traffic configuration, i.e. the QoS parameter or parameters applicable to traffic matching a defined traffic profile. The non-AP station receives the declaration and is thus aware of which traffic (thanks to the traffic profile) is considered as LLRS traffic subject to the declared QoS. The AP 110 may thus dynamically define the LLRS traffic and the associated QoS the AP guarantees, depending for example on the evolving network conditions.

Next, for instance based on station's needs in terms of LLRS traffic, the AP schedules, in the BSS, resources of the wireless network to traffic matching the defined traffic profile based on the applicable declared QoS parameters. More resources can be scheduled with more stringent QoS and with more LLRS traffic to transmit. The scheduled resources can then be accessed by the stations either to send their own LLRS traffic or to receive LLRS traffic. Such LLRS traffic may be UL, DL or even DiL traffic.

Advantageously, the AP 110 may define plural LLRS traffic configurations, i.e. plural sets of traffic characteristic values and plural respective sets of applicable QoS parameters or requirements.

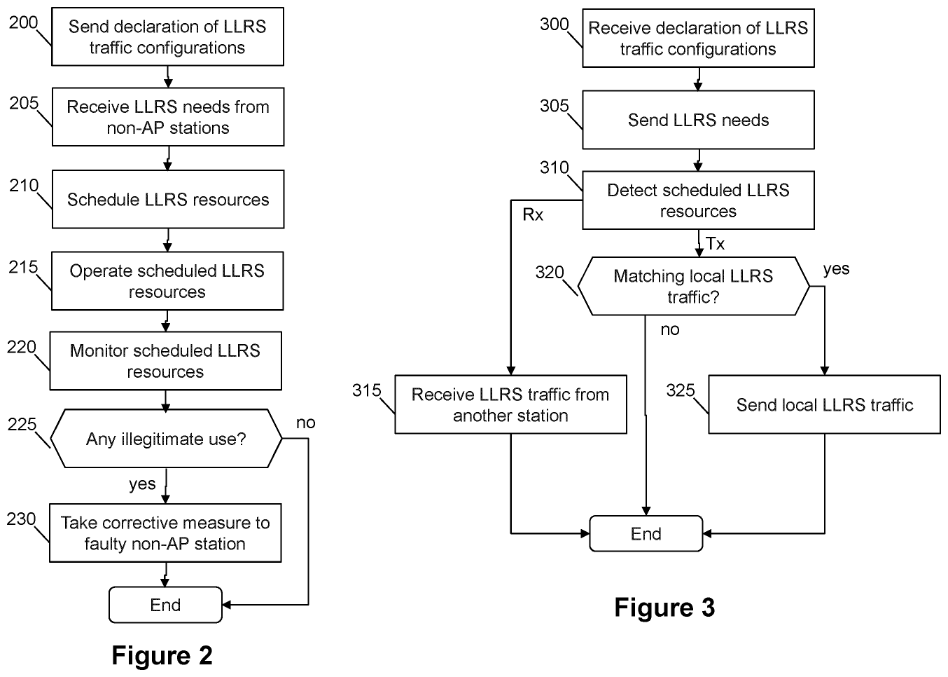

FIG. 2 illustrates, using a flowchart, general steps at the AP for managing the QoS for LLRS traffic according to some embodiments of the invention. Respectively, FIG. 3 illustrates, using a flowchart, general steps at a non-AP station for such LLRS QoS management according to some embodiments of the invention.

At step 200, the AP 110 advertises one or more LLRS traffic configurations at frame level to one or more non-AP stations. This includes declaring the QoS parameter or parameters applicable to the LLRS traffic or traffics, i.e. traffics matching respective defined traffic profiles.

The advertising may be provided to not-yet associated non-AP station, such as station 101. In that case, a management frame, such as a beacon frame or a probe response frame emitted during the association procedure, may be used that is sent by the AP 110 during the association of the non-AP station with the BSS.

A dedicated information element, IE, referred to as LLRS IE, can be used to advertise LLRS traffic configuration or configurations, i.e. a combination of a traffic profile (defining the traffic targeted) and associated QoS constraints or parameters. A LLRS IE can merely supplement existing IEs in the management frame.

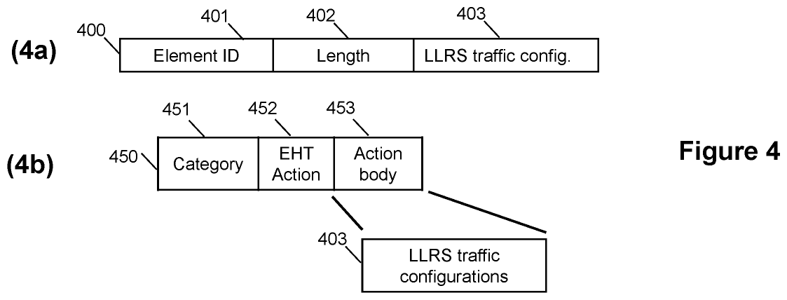

FIG. 4a illustrates an exemplary LLRS IE 400 made of a type-length-value (TLV) item. Of course, any combination of one or more of those parts is possible. For instance, the length value can be omitted if the IE length is fixed and known by all stations.

In the example of the Figure, Element ID subfield 401 identifies the IE 400 as being a LLRS IE according to embodiments of the invention. It may take a value in the range [245-254], so far reserved in the 802.11 standard. For the purpose of illustration, value 247 may be chosen in some embodiments.

Length subfield 402 indicates the number of bytes forming the LLRS IE 400 including the Element ID subfield 401 and the Length subfield 402.

LLRS traffic configuration subfield 403 includes one or more LLRS traffic configurations specified by the AP 110. The number of LLRS traffic configurations defined by the AP may vary. A single LLRS traffic configuration may for instance be defined. Of course, plural LLRS traffic configurations (i.e. with plural sets of traffic profiles and associated sets of QoS parameters) may also be defined should the AP desire offering various QoS for various types of data/traffics.

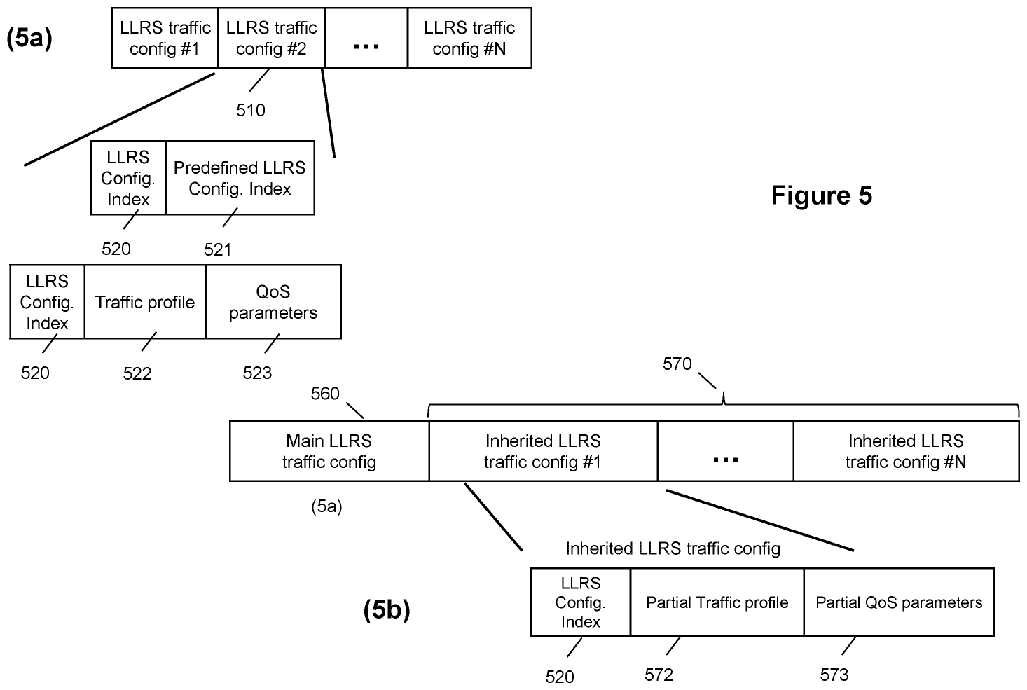

Exemplary embodiments of the LLRS traffic configuration subfield 403 are given below with reference to FIG. 5.

In a variant to the above, the advertising may be provided to already-associated non-AP stations, such as stations 102-107, i.e. during operation of the BSS. This advantageously makes it possible for the AP 110 to adjust or modify the LLRS traffic configurations over time, for instance when the network conditions evolve.

In that case, a management frame, such as a beacon frame or an action frame may be used during the life of the BSS, that is sent by the AP 110 to the non-AP stations of the BSS.

Declaration of the LLRS traffic configuration or configurations in the beacon frame may be done as explained above with reference to FIG. 4a, i.e. using LLRS IE 400.

As far as the action frame is concerned, a new action frame category may be defined that conveys the LLRS traffic configurations.

FIG. 4b illustrates the structure of an action frame as defined in section 9.6 of standard P802.11-REVmd/D5.0. It contains an action field 450 including a Category subfield 451, an EHT Action subfield 452 and an Action Body subfield 453.

Category subfield 451 is set to a value corresponding to an “EHT Action frame” as validated in the 802.11be (v0.3) standard. It may take a value in the range [21-125], so far reserved in the 802.11 standard. For the purpose of illustration, value 21 may be chosen in some embodiments.

EHT Action subfield 452 is set to a value identifying a LLRS Identification frame. It may take a value in the range [1-125], so far reserved in the 802.11be (v0.3) standard. For the purpose of illustration, value 1 may be chosen in some embodiments. This allows a non-AP station receiving the frame to directly understand it contains (in subfield 453) one or more LLRS traffic configurations.

Similar to the above LLRS traffic configuration subfield 403, Action Body subfield 453 contains one or more LLRS traffic configurations specified by the AP 110, an exemplary implementation of which is described with reference to FIG. 5.

FIG. 5 shows two main embodiments for advertising one or more LLRS traffic configurations in the advertising frames.

Basically, a LLRS traffic configuration combines a traffic profile and applicable QoS constraints or parameters. The traffic profile defines which data or traffic is concerned in this LLRS traffic configuration definition, i.e. the data or traffic to which the QoS is applicable. This is for this type of traffic (matching the traffic profile) that the AP 110 guarantees the QoS.

A traffic is defined by traffic characteristics. They are for instance a list of parameters characterizing the traffic concerned.

Exemplary and non exhaustive traffic characteristics include a Traffic type, a Data Rate (e.g. minimum and/or maximum or peak), a MSDU Size (e.g. minimum, maximum), a Burst size, a Service Interval (e.g. minimum and/or maximum), a Session Type, a Discard Age.

The Traffic type defines a type of traffic or data, depending for example on the upper layer application. For instance, it may be set to 0 for real-time gaming, 1 for cloud gaming, 2 for real-time video, and so on, as defined for instance in the IEEE 802.11-20/1852r1 document.

The Minimum/Peak Data Rate is the minimum/maximum allowable data rate. The Minimum/Maximum MSDU Size is the minimum/maximum size of the MSDUs. The Burst size is the maximum (and/or sometimes minimum) aggregate size of MSDUs allowed within a service interval.

The Minimum/Maximum Service Interval is the minimum/maximum MSDU interarrival time.

The Session Type indicates the type of transmission: for example, 0 for infrastructure transmission, 1 for Point to Point transmission.

The Discard Age is the maximum age of a MSDU after which the transmitter shall discard the MSDU, as defined for instance in the IEEE 802.11-20/1693r1 document.

Therefore, a traffic profile is made of one or more traffic characteristic values, for instance values for all or part of the above traffic characteristics.

On the other hand, the QoS parameters are those values representing transmission constraints that the AP must guarantee through appropriate scheduling of network resources.

Exemplary and non exhaustive QoS parameters include a Latency Bound, a Jitter, a Packet delivery ratio (PDR) as proposed in the IEEE 802.11-20/0418r4 document.

The Latency (or delay) Bound defines a time required for successfully delivery the MSDU/A-MPDUs. It may be defined as a maximum value authorized for any MSDU, a mean value for a group or all of MDSUs, a 99th percentile value (i.e. guaranteed successful delivery for 99% of the MSDUs), a 95th (or any other percentile value) percentile value, and so on.

The Jitter is the expected variation in latency. Again, it may be defined as a maximum jitter value authorized, a mean value, a 99th percentile value (i.e. guaranteed jitter for 99% of the delivered MSDUs), a 95th (or any other percentile value) percentile value, and so on.

The Packet delivery ratio (PDR) is the percentage of MSDUs delivered that are within the delay bound specified in the Latency Bound. It may also be defined as a maximum PDR value or a mean PDR value and so on.

As an example, a LLRS traffic configuration may be defined as any traffic with a data rate between minimum and maximum data rates (i.e. traffic profile) that requires a 2 ms maximum latency bound (i.e. QoS constraints). Another exemplary LLRS traffic may be defined as any real-time video with a given maximum MSDU size (i.e. traffic profile) that requires a minimum PDR together with a 10 ms maximum latency bound (i.e. QoS constraints).

Each LLRS traffic configuration may thus be made of a LLRS traffic configuration identifier, a set (or list) of one or more traffic characteristic values (the traffic profile) and a set (or list) of one or more applicable QoS parameters.

Traffic profiles may be predefined in advance, in which case the AP 110 can merely make reference to them, using for instance a unique identifier. Traffic profiles may also be dynamically defined by the AP 110 over time.

Several LLRS traffic configurations may be defined within the same advertising frame.

FIG. 5a illustrates embodiments defining LLRS traffic configurations 510 in a sequential way (when they are plural). These embodiments allow advertising a single LLRS traffic configuration 510.

According to a first format, a LLRS traffic configuration 510 is declared with a LLRS Configuration index field 520 and a predefined LLRS Configuration index field 521.

According to a second format, a LLRS traffic configuration 510 is declared with a LLRS Configuration index field 520 and a traffic profile field 522 and a QoS parameter field 523.

LLRS traffic configurations 510 according to the two formats may be combined within the same frame, in which case a proper signaling of the format used is made.

The LLRS Configuration index field 520 conveys an identifier or index of the LLRS traffic configuration 510. It is a value assigned by the AP 110 in order to uniquely identify each LLRS traffic configuration. In operation, this identifier can be used to indicate within the 802.11 frames the LLRS traffic configuration corresponding to the traffic conveyed in their payload. Also, it can be used by the AP 110 to tag each scheduled network resource with a specific (or multiple alternative) LLRS traffic configuration defining the type of traffic authorized. Typically, the assignment of the identifiers can be done by the AP in an incremental way.

The predefined LLRS Configuration index field 521 refers to a predefined LLRS traffic configuration. Therefore, the first format of FIG. 5a performs the declaration of a LLRS traffic configuration by specifying an index referring to a predefined LLRS configuration associating a defined traffic profile with QoS parameters.

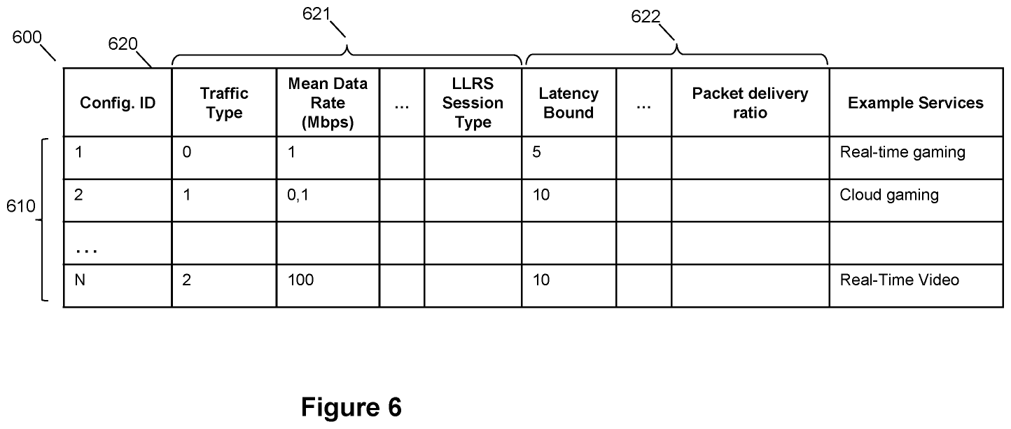

Typically, a predefined LLRS traffic configuration is issued from a table storing a set of predefined LLRS traffic configurations. Such a table is stored in a memory module of each station. FIG. 6 illustrates an exemplary table 600.

Table 600 contains a list of predefined LLRS Traffic Configurations 610.

Each predefined LLRS Traffic Configuration 610 is defined by a LLRS Configuration index 620, a traffic profile 621 and QoS parameters 622 specifying the QoS requirements guaranteed by the AP for traffic matching the associated traffic profile.

The traffic profile 621 is made of one or more traffic characteristic values defining the concerned data or traffic. For instance, a list of traffic characteristics may be provided or defined, and a field is provided in the traffic profile for each of the traffic characteristics where a value (traffic characteristics value), if applicable, is defined. Exemplary traffic characteristics are provided above.

The QoS parameters 622 contain the QoS constraints applicable for the traffic profile 621. A list of QoS parameters may be provided or defined, and a field is provided for each of the Qos parameters where a value, if applicable, is defined. Exemplary QoS parameters are provided above.

Turning now to the second format of FIG. 5a, the traffic profile field 522 contains the traffic characteristic values to define the concerned data or traffic (similar to field 621). Similarly, the QoS parameter field 523 contains the QoS constraints applicable to any traffic matching the traffic profile of field 522 (similar to field 622).

In this embodiment, the declaration of a LLRS traffic configuration is made by specifying the one or more QoS parameters in association with one or more traffic characteristic values defining the defined traffic profile.

In an alternative, traffic profiles may be predefined (e.g. a table in memory of all stations) and the traffic profile field 522 may only specify an index referring to one of the predefined traffic profiles. This is to reduce signaling overhead. In this alternative, the declaration of a LLRS traffic configuration is made by specifying the one or more QoS parameters in association with a profile identifier identifying the defined traffic profile.

FIG. 5b illustrates other embodiments which define LLRS traffic configurations in an inheritance way.

The illustrated format advertises a main LLRS traffic configuration 560 and a list of one or more inherited LLRS traffic configurations 570. Therefore, a plurality of QoS parameter sets is declared that are applicable to plural traffics matching respective defined traffic profiles.

The main LLRS traffic configuration 560 is the first LLRS traffic configuration in the frame and may match any self-contained format of the LLRS traffic configuration 510 of FIG. 5a. In some embodiments, more than a single main LLRS traffic configuration 560 can be signalled using a self-contained format.

An Inherited LLRS traffic configuration 570 follows an inheritance format. It is defined with reference to the main (or one main) LLRS traffic configuration 560. It means that a next LLRS traffic configuration (i.e. next QoS parameter set for next defined traffic profile) is defined with inheritance from a previous (here main) LLRS traffic configuration (i.e. a previous QoS parameter set for a previous defined traffic profile).

The Inherited LLRS traffic configuration 570 comprises a LLRS Configuration index field 520, a partial traffic profile field 572 and a partial QoS parameter field 573. Where several main LLRS traffic configuration 560 are defined, an optional LLRS Main Configuration index field 571 (not shown) may be provided to specify from which main LLRS traffic configuration, the current Inherited LLRS traffic configuration 570 inherits. This may be useful when the main LLRS traffic configurations do not have the same lists of traffic characteristics and/or of QoS parameters.

The partial traffic profile field 572 provides replacing traffic characteristics values that replace, when specified, the corresponding values 522 from the main LLRS traffic configuration 560. It means that the traffic characteristic values (forming the traffic profile) of an inherited LLRS traffic configuration 570 corresponds to the traffic characteristic values 522 of the main LLRS traffic configuration 560 except for the traffic characteristics included in the partial traffic profile field 572 for which their values replace the values specified in the traffic profile 522 of the main LLRS traffic configuration 560.

The partial QoS parameter field 573 provides replacing QoS values that replace, when specified, the corresponding values 523 from the main LLRS traffic configuration 560. It means that the QoS parameters of an Inherited LLRS traffic configuration 570 corresponds to the QoS parameters 523 of the main LLRS traffic configuration 560 except for the QoS parameters including in partial QOS parameter field 573 for which their values replace the values 523 specified in the QoS parameters of the main LLRS traffic configuration 560.

With the inheritance, declaring the next (here inherited) LLRS traffic configuration (i.e. the next QoS parameter set for the next defined traffic profile) includes declaring replacing values that replace one or more of QoS parameter values and traffic characteristic values of the previous (here main) LLRS traffic configuration (i.e. previous QoS parameter set and defined traffic profile).

Back to FIGS. 2 and 3, once the advertising frame as described above is ready, it is sent by the AP 110 at step 200. It is received by one or more non-AP stations at step 300.

The advertising frame may be multicast or broadcasted to all the non-AP stations, for instance when it is the beacon frame or to a group of non-AP stations using an action frame for example. It may be also be unicast to a non-yet associated station during its association procedure, using for instance a probe response frame.

The non-AP station receiving the advertising frame (or frames) is now aware of the LLRS traffics for which the AP 110 guarantees declared QoS using appropriate LLRS mechanisms to schedule resources.

A not-yet associated station seeking for a BSS handling a particular LLRS traffic (i.e. QoS for specific LL data) may check whether this particular LLRS traffic is managed by the AP of the BSS by reading the declared LLRS traffic configurations. If the particular LLRS traffic matches one of the declared LLRS traffic configurations, the station may decide completing the association with that BSS. On the other hand, if the particular LLRS traffic matches none of the declared LLRS traffic configurations, the station may decide not completing the association with that BSS. Hence deciding to associate or not with a BSS may be based on the LLRS traffic configurations declared by the AP.

The associated non-AP station may then determine at step 305 whether it has LLRS traffic to transmit (e.g. in transmission buffer or as needs declared by an upper layer application). Step 305 may simply check whether the station has traffic matching the traffic profile of one of the declared LLRS traffic configurations 510/560/570.

In the affirmative, the station may transmit its LLRS needs (still at step 305) to the AP 110. This may be done using any type of signalling, for example a Buffer Status Report (BSR) enabling the signalling of LLRS traffic (optionally distinguishing between the various LLRS traffic configurations declared by the AP). A non-AP station may for example signal a first amount of stored data corresponding to a first LLRS traffic configuration and a second amount of stored data corresponding to a second LLRS traffic configuration.

In other words, the non-AP station declares, to the AP, local traffic matching the defined traffic profile as previously declared by the AP.

This signalling of the LLRS needs by the non-AP stations helps the AP to efficiently schedule appropriated network resources to the stations to meet the applicable declared QoS parameters for all declared LLRS traffic configurations. This also makes it possible to analyse the evolution of the network loads and then adapt, if needed, the LLRS traffic configurations. For instance, QoS parameters may be modified when the network conditions evolve. Also, a LLRS traffic configuration may no longer exist (thus is deleted) when the network conditions deteriorate too much or a new LLRS traffic configuration may be declared or reactivated when the network conditions improve sufficiently.

At step 205, the AP 110 receives and gathers all the needs from the various non-AP stations. This step may be continuously performed over time, as the non-AP stations may be regularly polled to obtain their BSRs.

Based on the gathered LLRS needs, the AP 110 determine at step 210 network resources in terms of bandwidth and duration to be offered to the LLRS traffic configurations in order to guarantee the declared QoS constraints. The AP 110 next schedules the determined network resources.

For instance, one or more protected TWT service periods may be provided, dedicated to one or more LLRS traffic configurations for which station needs have been received. Alternatively or in combination, specific resource units for the LLRS traffic configurations may be provided in a MU OFDMA transmission. Of course, any scheme to schedule network resources to stations having LLRS needs can be used.

More generally, any low latency operation scheduling resources specific to LLRS traffic may be contemplated, that gives priority to such LLRS traffic over conventional 802.11e AC traffics. This includes the LL reliable services at the AP.

The scheduled resources may be individually tagged with an identifier (see field 520) of the LLRS traffic configuration defining the traffic authorized in the resource.

Next to step 210, the AP operates at step 215 the scheduled resources. This may include transmitting LLRS data to one or more non-AP stations (DL transmission) and/or receiving LLRS traffic from such non-AP stations (UL transmissions).

On the other side, the non-AP station involved with LLRS traffic detects at step 310 scheduled LLRS resources. This may be resources assigned to it specifically (e.g. scheduled RUS in MU OFDMA transmission) or general resources to which it has to contend in order to access it. Each scheduled LLRS resource may be tagged with an indication of a LLRS traffic configuration, hence restricting the type of data the station is authorized to send or receive over the resource.

In the affirmative of a scheduled resource it may operate, next step consists in operating the scheduled resource, either by receiving DiL or DL LLRS traffic from another station (step 315) or by determining (step 320) whether it has LLRS traffic to send that matches the LLRS traffic configuration of the scheduled resource and then (step 325) transmitting such matching LLRS traffic (UL or DiL transmission) in the scheduled resource. In other words, the non-AP station determines that local traffic matches the defined traffic profile and responsively accesses the scheduled resources to send the local traffic.

Steps 215, 315-325 are repeated over time as the AP 110 schedules new network resources to LLRS traffic, thus ensuring the declared QoS is satisfied.

To avoid illegitimate use of the scheduled resources, the AP 110 may optionally at step 220 monitor the use of the scheduled resources, in particular monitor that the traffic transmitted therein matches the applicable defined traffic profile.

This may be done by analyzing the data transmitted and checking they match the traffic profile associated with the LLRS traffic configuration assigned to the scheduled resource. For example, the AP checks the stream of packets sent in the scheduled resources have traffic characteristics matching the traffic profile.

When the AP detects (test 225) a non-AP station transmitting traffic not matching the defined traffic profile in the scheduled resources, it applies at step 230 a correcting measure to the detected faulty non-AP station. A correcting measure may merely consist in no longer providing (or temporarily not providing) new scheduled resources to the faulty non-AP station, either for any LLRS traffic or only for the faulty LLRS traffic. An alternate correcting measure may consist in disassociating the faulty non-AP station from the BSS. Of course, other correcting measure may be contemplated.

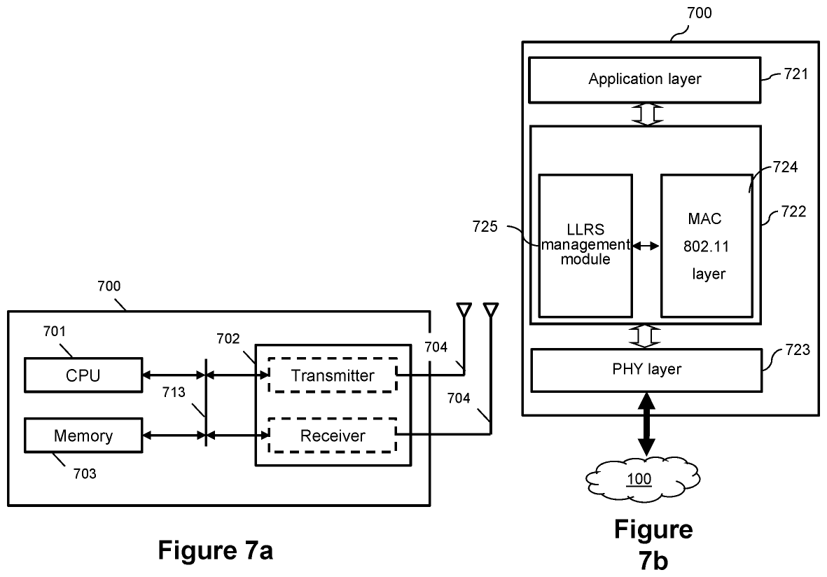

FIG. 7a schematically illustrates a communication device 700, either a non-AP station 101-107 or the AP 110, of the radio network 100, configured to implement at least one embodiment of the present invention. The communication device 700 may preferably be a device such as a micro-computer, a workstation or a light portable device. The communication device 700 comprises a communication bus 713 to which there are preferably connected:
a central processing unit 701, such as a processor, denoted CPU;
a memory 703 for storing an executable code of methods or steps of the methods according to embodiments of the invention as well as the registers adapted to record variables and parameters necessary for implementing the methods; and
at least one communication interface 702 connected to a wireless communication network, for example a communication network according to one of the IEEE 802.11 family of standards, via transmitting and receiving antennas 704.

Preferably the communication bus provides communication and interoperability between the various elements included in the communication device 700 or connected to it. The representation of the bus is not limiting and in particular the central processing unit is operable to communicate instructions to any element of the communication device 700 directly or by means of another element of the communication device 700.

The executable code may be stored in a memory that may either be read only, a hard disk or on a removable digital medium such as for example a disk. According to an optional variant, the executable code of the programs can be received by means of the communication network, via the interface 702, in order to be stored in the memory of the communication device 700 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

FIG. 7b is a block diagram schematically illustrating the architecture of the communication device 700, either the AP 110 or one of stations 101-107, adapted to carry out, at least partially, the invention. As illustrated, device 700 comprises a physical (PHY) layer block 723, a MAC layer block 722, and an application layer block 721.

The PHY layer block 723 (here typically an 802.11 standardized PHY layer) has the task of formatting, modulating on or demodulating from any 802.11 channel, and thus sending or receiving frames over the radio medium used 100, such as 802.11 frames, for instance management frames and MPDUs.

The MAC layer block or controller 722 preferably comprises an 802.11 MAC layer 724 implementing conventional 802.11ax/be MAC operations, and additional block 725 for carrying out, at least partially, embodiments of the invention. The MAC layer block 722 may optionally be implemented in software, which software is loaded into RAM 703 and executed by CPU 701.

Preferably, the additional block 725, referred to as LLRS management module, implements the part of embodiments of the invention (either from station perspective or from AP perspective). This block performs the operations of FIG. 2 or 3, depending on the role of the communication device 700.

802.11 MAC layer 724, LLRS management module 725 interact one with the other in order to process accurately LLRS communications over the wireless medium according to embodiments of the invention.

On top of the Figure, application layer block 721 runs an application that generates and receives data packets, for example data packets such as a video stream, video game, and so on. Application layer block 721 represents all the stack layers above MAC layer according to ISO standardization.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A communication method in a wireless network, comprising at an access point, AP, station of a basic service set, BSS:
declaring, to one or more non-AP stations, a profile identifier identifying a defined traffic profile, and
scheduling, in the BSS, resources of the wireless network to traffic matching the defined traffic profile based on the declared profile identifier.

2. A communication method in a wireless network, comprising at a non-access point, non-AP, station:
receiving, from an AP station of a basic service set, BSS, a frame declaring a profile identifier identifying a defined traffic profile, and
accessing resources of the wireless network that are scheduled by the AP in the BSS to traffic matching the defined traffic profile in order to receive or send such traffic.

3. The communication method of claim 1, wherein declaring includes using a management frame, such as a beacon frame or a probe response frame, sent by the AP station during the association of the non-AP station with the AP station.

4. The communication method of claim 1, wherein declaring includes using a management frame, such as a beacon frame or an action frame, sent by the AP station to the non-AP stations of the BSS.

5. The communication method of claim 1, wherein declaring includes specifying an index referring to a predefined configuration associating the defined traffic profile with QoS parameters.

6. The communication method of claim 1, wherein declaring further includes specifying one or more QoS parameters in association with the profile identifier to define one or more QoS parameters applicable to traffic matching the defined traffic profile.

7. (canceled)

8. (canceled)

9. The communication method of claim 1, wherein declaring further includes declaring a plurality of QoS parameter sets applicable to plural traffics matching respective defined traffic profiles.

10. (canceled)

11. (canceled)

12. (canceled)

13. The communication method of claim 1, wherein scheduling is made upon detecting needs of one or more of the stations for transmitting traffic matching the defined traffic profile.

14. The communication method of claim 1, wherein scheduling includes scheduling a protected Target Wake Time, TWT, service period for traffic matching the defined traffic profile.

15. The communication method of claim 1, further comprising, at the AP station, monitoring use of the scheduled resources that the traffic transmitted therein matches the defined traffic profile.

16. The communication method of claim 15, further comprising, at the AP station, upon detecting a non-AP station transmitting traffic not matching the defined traffic profile in the scheduled resources, applying a corrective measure to the detected non-AP station.

17. The communication method of claim 2, further comprising, at the non-AP station, determining that local traffic matches the defined traffic profile and responsively accessing the scheduled resources to send the local traffic.

18. The communication method of claim 2, further comprising, at the non-AP station, declaring, to the AP station, local traffic matching the defined traffic profile.

19. A non-transitory computer-readable medium storing a program which, when executed by a microprocessor or computer system in a wireless device of a wireless network, the wireless device configured as an access point, AP, station of a basic service set, BSS, causes the wireless device to perform operations comprising:
declaring, to one or more non-AP stations, a profile identifier identifying a defined traffic profile, and
scheduling, in the BSS, resources of the wireless network to traffic matching the defined traffic profile based on the declared profile identifier.

20. A wireless communication device of a wireless network, the wireless device configured as an access point, AP, station of a basic service set, BSS and comprising:
at least one microprocessor configured to perform operations comprising:
declaring, to one or more non-AP stations, a profile identifier identifying a defined traffic profile, and
scheduling, in the BSS, resources of the wireless network to traffic matching the defined traffic profile based on the declared profile identifier.
